(19) United States
(12) Patent Application Publication
(10) Pub. No.: US 2021/0103539 A1
(43) Pub. Date: Apr. 8, 2021

(54) DELEGATION OF UNIVERSAL SERIAL BUS POWER AMONG MULTIPLE PORTS

(71) Applicant: Hewlett-Packard Development Company, L.P., Spring, TX (US)

(72) Inventors: Christopher Woodbury, Spring, TX (US); Xianglong Du, Spring, TX (US); Robert C. Brooks, Spring, TX (US)

(73) Assignee: Hewlett-Packard Development Company, L.P., Spring, TX (US)

(21) Appl. No.: 17/048,111

(22) PCT Filed: Jun. 14, 2018
(86) PCT No.: PCT/US2018/037543

§ 371 Date: Oct. 16, 2020

(51) Int. Cl. G06F 13/38; G06F 13/42; G06F 1/26; G06F 1/3206

(52) U.S. Cl. CPC G06F 13/385; G06F 1/3206; G06F 1/266; G06F 13/4282

(57) ABSTRACT

A circuit includes a port manager to monitor requested port power from each of a plurality of universal serial bus (USB) ports. The port manager sets a separate port variable for each of the USB ports that indicates a priority in which each of the USB ports have requested port power. A controller monitors the separate port variables from the port manager for each of the USB ports. The controller delegates power to the USB ports based on the priority assigned by the port manager.

### BACKGROUND

New universal serial bus (USB) power-delivery (PD) and Type-C specifications have been released that enable delivery of higher power over USB cables and connectors. The intent for this technology is to create a universal power plug for laptops, tablets, and so forth. The USB-PD specification defines a communication link between ports connected via USB-PD cables and connectors. The communication is designed to be half-duplex and packet-based. The packets include various information that enables the two ports to communicate and negotiate the voltage and current the source port will provide to the sink port. This communication happens independently from normal USB communications that route through the same cable but use different wires.

### BRIEF DESCRIPTION OF THE DRAWINGS

FIG. 1 illustrates an example block diagram of a circuit to delegate power to multiple universal serial bus (USB) ports based on priority of device access to the ports.

FIG. 2 illustrates an example block diagram of a circuit to delegate power to multiple universal serial bus (USB) ports based on priority of device access to the ports and requested power from the ports.

FIG. 3 illustrates an example block diagram of a circuit to delegate power to multiple universal serial bus (USB) ports having a negotiation interfaces to negotiate power to and from the ports.

FIG. 4 illustrates an example of universal serial bus signal connections for delegating power to multiple universal serial bus (USB) ports.

FIG. 5 illustrates an example method to delegate power to multiple universal serial bus (USB) ports.

### DETAILED DESCRIPTION

This disclosure relates to circuits and methods to delegate power to multiple universal serial bus (USB) ports based on priority of device access to the respective USB ports. A port manager operating on or with a controller monitors requested port power from each of a plurality of USB ports. The port manager sets a separate port variable for each of the USB ports that indicates a priority in which each of the USB ports have requested port power. For example, if device (A) plugs into USB port (A) before another device (B) plugs into USB port (B), then device (A) can be assigned a higher priority than device (B). The controller monitors the separate port variables from the port manager for each of the USB ports. The controller then delegates power to the USB ports based on the priority assigned by the port manager. In one example, the highest priority device (device (A) in this example) can be allocated full power for charging and/or other power needs whereas devices assigned lower priority can be allocated power levels less than full power. This type of priority control mitigates users from receiving more combined power from multiple USB ports than should be supplied from the power supply driving the respective USB ports. In some examples, devices can negotiate for less power on power-up which can be used to supply other devices of lower priority that may request more power. In yet other examples, if a higher priority device has disconnected, remaining connected devices can dynamically renegotiate their current power allocation with the port manager based on their previously assigned priority.

As used herein, the term “circuit” can include a collection of active and/or passive elements that perform a circuit function, such as an analog circuit or control circuit. Additionally or alternatively, for example, the term “circuit” can include an integrated circuit (IC) where all and/or some of the circuit elements are fabricated on a common substrate (e.g., semiconductor substrate, such as a die or chip).

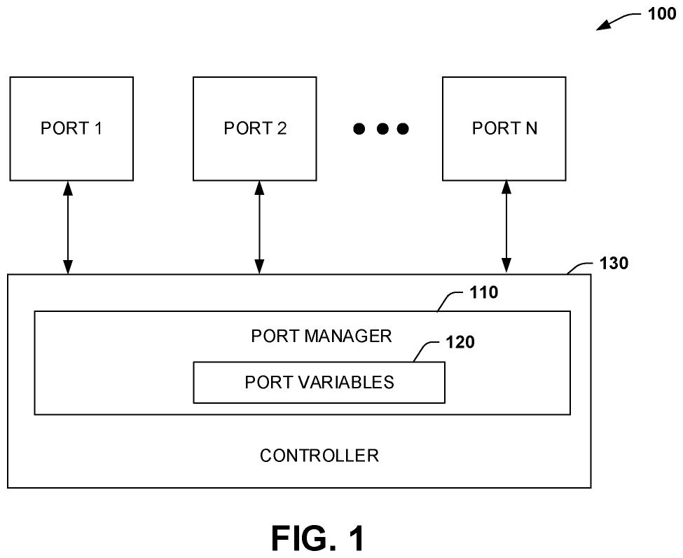

FIG. 1 illustrates an example of a circuit 100 to delegate power to multiple universal serial bus (USB) ports shown as ports 1 through N based on priority of device access to the ports, with N being a positive integer. The circuit 100 includes a port manager 110 to monitor requested port power from each of a plurality of universal serial bus (USB) ports 1-N. The port manager 110 sets a separate port variable 120 for each of the USB ports 1-N that indicates a priority in which each of the USB ports have requested port power. As used herein, the term priority refers to the order in which a device plugs into a given port. If a device A for example, plugs into any of the ports 1-N before device B plugs into another port, then device B is assigned a lower priority (e.g., numerical priority) than device A. If a concurrent condition were to occur where two devices were plugged in at a similar time or two devices were plugged in when the device such as a laptop housing the ports 1-N was powered up, then a predetermined priority can be assigned (e.g., device in the left most port receives highest priority). A controller 130 monitors the separate port variables 120 from the port manager 110 for each of the USB ports 1-N. The controller 130 delegates power to the USB ports based on the priority assigned by the port manager. As used herein, the term delegates refers to assigning how much power—current and/or voltage a given devices receives. The controller 130 can directly control the delegation of power and/or indirectly control the delegation by sending some other device such as a power supply a command (e.g., a command code) describing how much power to assign to a given port.

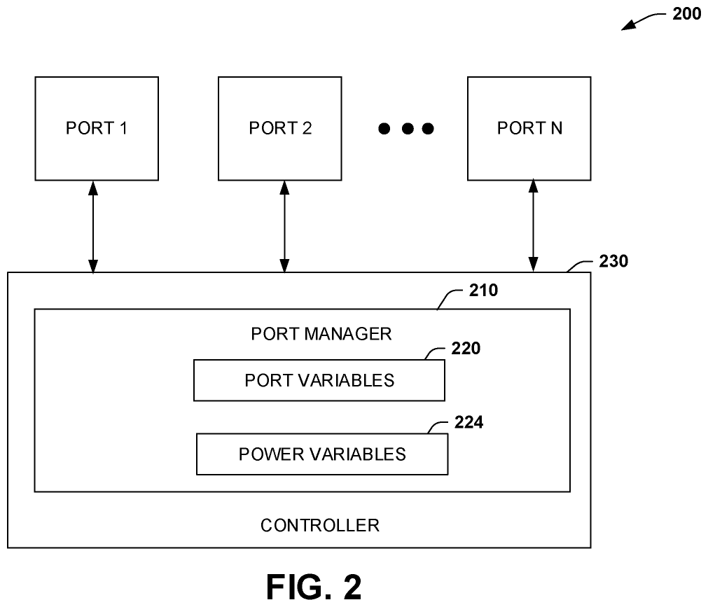

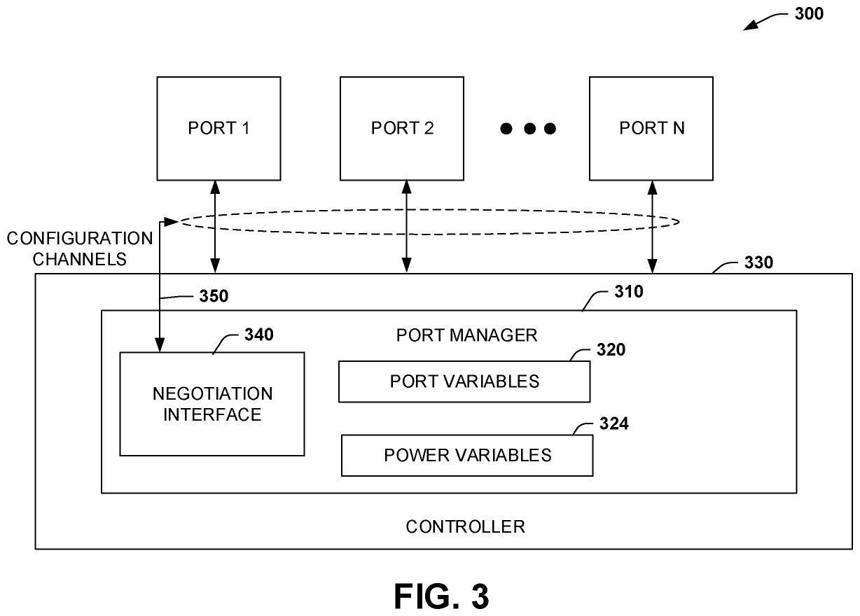

In an example, the port manager 110 can analyze the requested port power from each of the plurality of USB ports 1-N and determine an allocation of the port power for each of the USB ports based on the priority and an amount of power requested from each of the USB ports. The port manager 110 can set a separate power variable (see e.g., FIG. 2) for each of the USB ports 1-N that indicates the amount of power requested and the controller 130 can delegate power to the USB ports based on the priority and the amount of power requested. A negotiation interface (not shown, see e.g., FIG. 3) can negotiate the amount of power delegated by the controller 130 to devices connected with each of the USB ports 1-N.

In another example, the controller 130 delegates a greater amount of power to devices having a higher priority as set by the port manager 110 and negotiated by the negotiation interface with each of the USB ports 1-N. In this manner, overall power requested from the collection of USB ports can be controlled. In yet another example, the controller 130 delegates a greater amount of power to devices having a lower priority as set by the port manager 110 and negotiated by the negotiation interface with each of the USB ports 1-N if a device of higher priority is disconnected from its respective USB port. In some examples, a negotiation can occur when devices are plugged into a respective USB port where a given device can notify the port manager 110 that less than full power is requested. In such example, the controller 130 can delegate a greater amount of power to devices having a lower priority as set by the port manager 110 and negotiated by the negotiation interface with each of the USB ports if a device of higher priority negotiates a lower power from its respective USB port than a device of lower priority negotiates from its respective USB port.

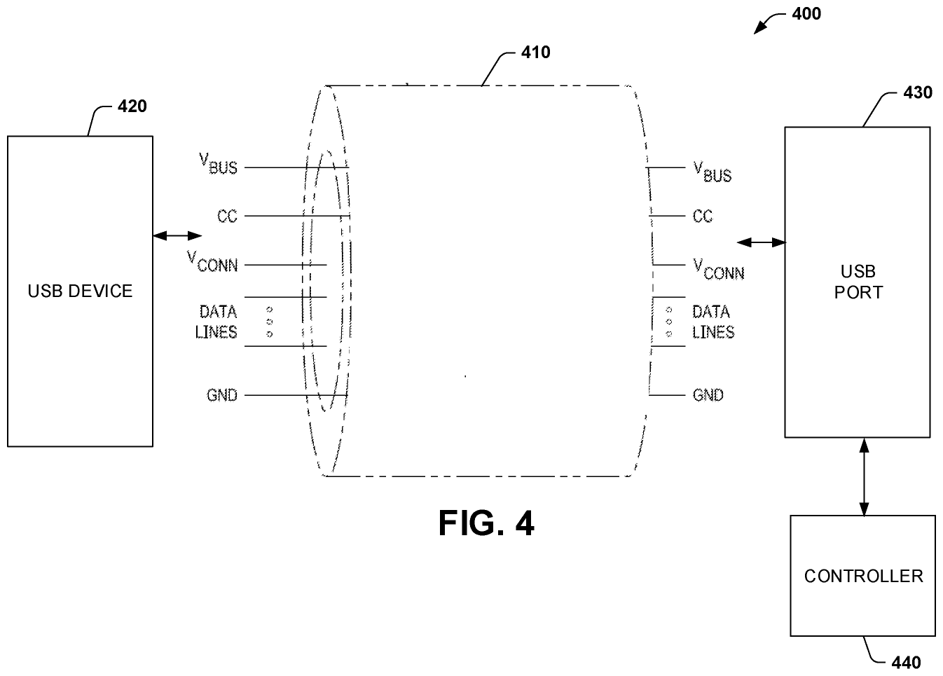

For other examples, the negotiation interface renegotiates the amount of power delegated by the controller 130 to each remaining device connected to the respective USB ports 1-N if a given device is disconnected from its respective USB port. The negotiation interface sends or receives power allocation data on a configuration channel (see e.g., FIGS. 3 and 4) of the USB ports 1-N via a bi-phase mark coding protocol (BMC). The negotiation interface described herein can also generate a source capability message via the configuration channel to a given device connected to the respective USB port 1-N, where the negotiation interface modifies the source capability message sent to the given device to be a different voltage or a different current than requested based on the assigned priority and/or the amount of power requested.

The circuits and methods described herein mitigates the condition of the user from configuring USB ports to be able to pull unsuitably high levels of power at one time. Therefore, such circuits and methods can reduce power to USB ports based on which or how many ports are currently in use. For example, in a system that contains two USB type C ports, if one port is currently in use, the other port power can be reduced thus preventing the user from drawing a full 15 W from both available USB type C ports and in an effort to limit the amount of power being collectively consumed by the USB ports. This also allows more power headroom to be available for more important resources or tasks running on the central processing unit (CPU). This in turn allows for smaller power supplies due to the increased power headroom. Also, the circuits and methods described herein facilitates from having high current spikes generated during runtime caused by the USB ports. The USB ports alone in current systems can be configured to consume more power than the rating of the power supply, for example. By managing port charging, the total amount of power consumed by the ports can be decreased.

In one specific example using three ports, three USB ports are provided that support high current charging. These ports have a full power state, a reduced power state, and a charging disabled state such as:

1. USB-C: Full power=15 W @ (5V, 3 A)

Reduced power=7.5 W @ (5V, 1.5 A)

Charging disabled=4.5 W @ (5V, 0.9 A)

2. USB-C: Full power=15 W @ (5V, 3 A)

Reduced power=7.5 W @ (5V, 1.5 A)

Charging disabled=4.5 W @ (5V, 0.9 A)

3. USB-A CHG: Full power=12.5 W @ (5V, 2.5 A)

Reduced power=7.5 W @ (5V, 1.5 A)

Charging disabled=4.5 W @ (5V, 0.9 A)

When the user performs the action to insert a device into any of the three ports, the other two ports enter into the reduced power state such as:

1. USB-C: Full power=15 W @ (5V, 3 A) Occupied

2. USB-C: Reduced power=7.5 W @ (5V, 1.5 A) Unoccupied

3. USB-A CHG: Reduced power=7.5 W @ (5V, 1.5 A) Unoccupied

From this state when the user performs the action to insert an additional device into the remaining two open ports, the last remaining port enters into the charging disabled state

1. USB-C: Full power=15 W @ (5V, 3 A) Occupied

2. USB-C: Reduced power=7.5 W @ (5V, 1.5 A) Occupied

3. USB-A CHG: Charging disabled=4.5 W @ (5V, 0.9 A) Occupied/Unoccupied

This procedure can be performed given that the user inputs a device into any of the open ports. Given how many ports are available (e.g., no device occupies the port) the power state is changed accordingly. Given that there are three USB ports (USB C 1, USB C 2, and USB A CHG) there are three possible configurations that can be obtained when the user performs the action to insert a device into one of the three available charging ports. The user can either insert the device into one of the USB-C or the USB-A CHG. Then the two ports that are not occupied enter into the reduced, half power state.

Thus, a summary of a configuration with only one device inserted into the unit includes:

There is one state available for each charging port:

If system has 3 charging ports, there are 3 possible state configurations.

The remaining, not occupied, ports only support up to half power.

A device cannot draw full power from a half power port. Other configurations are possible however.

Given that the users' first action is to insert a device into one of the three open ports the user can then insert an additional second device into one of the two open ports, this now results in six possible configurations.

Thus, a summary of a configuration with two devices inserted into the unit includes:

Only the first device inserted supports full power.

Only the second device inserted supports half power.

The remaining, not occupied, ports do not support charging (charging disabled).

These ports allow default, 0.9 A current, for example.

When, a device is removed, currently inserted devices can renegotiate to the highest allowed power configuration as mentioned previously. When considering the case where only one device has been inserted, and the configuration is one of three. Then by removing the device, respective charging USB devices return to a full power supported initial state.

Thus, a summary of a configuration when removing one device from the unit includes:

When the device is removed, respective charging ports allow full power.

This returns to the initial state where no devices occupy any of the charging ports.

When considering the case where there are two inserted devices, when one device is removed, the remaining devices can renegotiate to a higher allowed power state. For instance, consider the configuration where the user first inserted a device into USB-C which supported up to full power, then the user inserted a second device into the USB-A charger which supported up to half power. At this point, the user can either remove the USB-C device or the USB-A charger device. If the user removes the USB-C device, then a possible result is where USB-A charging device restores to full power and remaining unoccupied ports are allowed reduced power. In another example, the user can remove the second device in USB-A charger which results in USB-C device restores to full power (e.g., USB-C was the 1^{st} device plugged in & already had full power, so does not need to “restore” full power) and remaining unoccupied ports are allowed reduced power.

When in a two-device state, for example, when one state is removed, the remaining occupied port can renegotiate power. This allows the remaining device the ability to consume full power from the port it occupies. Since this device now has the option to consume more power, an assumption can be made that the device may consume more power. This allows us to cover every case and simplify the state table.

Thus, a summary of a configuration when removing two devices from the unit includes:

When any of the two devices is removed, the charging ports return to a one device state.

This is achieved by renegotiating and allowing full power to the remaining port.

FIG. 2 illustrates an example of a circuit 200 to delegate power to multiple universal serial bus (USB) ports 1-N based on priority of device access to the ports and requested power from the ports. In this example, a port manager 210 monitors requested port power from each of a plurality of universal serial bus (USB) ports 1-N. The port manager 210 sets a separate port variable 220 for each of the USB ports 1-N that indicates a priority in which each of the USB ports have requested port power. The port manager 210 can also analyze the requested port power from each of the plurality of USB ports 1-N and determine an allocation of the port power for each of the USB ports based on the priority and an amount of power requested from each of the USB ports. The port manager 210 sets a separate power variable 224 for each of the USB ports 1-N that indicates the amount of power requested. A controller monitors the separate port variables 220 and power variables 224 from the port manager 210 for each of the USB ports 1-N. The controller 230 delegates power to the USB ports 1-N based on the priority and the amount of power requested in this example. A negotiation interface is illustrated and described below with respect to FIG. 3 to interact with devices that plug and unplug from the respective USB ports 1-N.

FIG. 3 illustrates an example of a circuit 300 to delegate power to multiple universal serial bus (USB) ports 1-N having a negotiation interfaces to negotiate power to and from the ports. Similar to the circuit 200 described above with respect to FIG. 2, The circuit 300 includes a port manager 310 that monitors requested port power from each of a plurality of universal serial bus (USB) ports 1-N. The port manager 310 sets a separate port variable 320 for each of the USB ports 1-N that indicates a priority in which each of the USB ports have requested port power. The port manager 310 can also analyze the requested port power from each of the plurality of USB ports 1-N and determine an allocation of the port power for each of the USB ports based on the priority and an amount of power requested from each of the USB ports. The port manager 310 sets a separate power variable 324 for each of the USB ports 1-N that indicates the amount of power requested. A controller 330 monitors the separate port variables 320 and power variables 324 from the port manager 310 for each of the USB ports 1-N. The controller 330 delegates power to the USB ports 1-N based on the priority and the amount of power requested in this example.

A negotiation interface 340 can be provided to negotiate the amount of power delegated by the controller 330 to devices connected with each of the USB ports 1-N. In one example, the controller 330 delegates a greater amount of power to devices having a higher priority as set by the port manager 310 and negotiated by the negotiation interface 340 with each of the USB ports 1-N. As shown, power negotiation can occur over configuration channels 350, where each USB port is assigned its own channel. In another example, the controller 330 delegates a greater amount of power to devices having a lower priority as set by the port manager 310 and negotiated by the negotiation interface 340 with each of the USB ports 1-N if a device of higher priority is disconnected from its respective USB port. In yet another example, the controller 330 delegates a greater amount of power to devices having a lower priority as set by the port manager 310 and negotiated by the negotiation interface 340 with each of the USB ports 1-N if a device of higher priority negotiates a lower power from its respective USB port than a device of lower priority negotiates from its respective USB port.

FIG. 4 illustrates an example of universal serial bus signal connections for delegating power to multiple universal serial bus (USB) ports. Although a USB type C example is shown in FIG. 4, any type of USB versions may be supported by the power delegation circuits and methods described herein (e.g., USB 2.0). As shown, a USB cable 410 connects a USB device 420 to a given USB port 430 that is monitored and controlled by a controller 440 as described herein. The USB cable 410 can include power connections shown as VBUS, VCONN, and ground GND. Data lines transfer USB data and a configuration channel (CC) is provided for negotiating power between the USB device 420 and controller 440 via the USB port 430. The cable 410 includes a VBUS connection, a VCONN connection, a configuration channel (CC) connection, data lines for normal USB communications, and ground GND in this example but other signals may be supported in other examples. In this example, the power can be supplied by the VBUS connection but it can also be supplied from the VCONN connection.

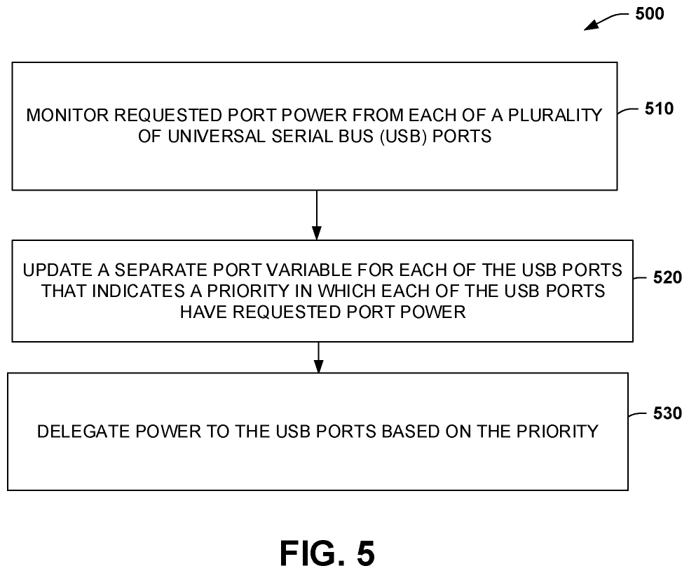

In view of the foregoing structural and functional features described above, an example method will be better appreciated with reference to FIG. 5. While, for purposes of simplicity of explanation, the method is shown and described as executing serially, it is to be understood and appreciated that the method is not limited by the illustrated order, as parts of the method could occur in different orders and/or concurrently from that shown and described herein. Such methods can be executed by various hardware circuits and components configured to execute machine readable instructions stored in memory and executable by an integrated circuit or a processor, for example.

FIG. 5 illustrates an example method 500 to delegate power to multiple universal serial bus (USB) ports. At 510, the method 500 includes monitoring requested port power from each of a plurality of universal serial bus (USB) ports. At 520, the method 500 includes updating a separate port variable for each of the USB ports that indicates a priority in which each of the USB ports have requested port power. At 530, the method 500 includes delegating power to the USB ports based on the priority. Although not shown, the method 500 can also include determining an amount of power requested from each of the USB ports. This can include negotiating power to the USB ports based on the priority and the requested power.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A circuit comprising:
a port manager to monitor requested port power from each of a plurality of universal serial bus (USB) ports, the port manager to set a separate port variable for each of the USB ports that indicates a priority in which each of the USB ports have requested port power; and
a controller to monitor the separate port variables from the port manager for each of the USB ports, the controller to delegate power to the USB ports based on the priority assigned by the port manager.

2. The circuit of claim 1, wherein the port manager to analyze the requested port power from each of the plurality of USB ports and to determine an allocation of the port power for each of the USB ports based on the priority and an amount of power requested from each of the USB ports.

3. The circuit of claim 2, wherein the port manager to set a separate power variable for each of the USB ports that indicates the amount of power requested and the controller to delegate power to the USB ports based on the priority and the amount of power requested.

4. The circuit of claim 2, further comprising a negotiation interface to negotiate the amount of power delegated by the controller to devices connected with each of the USB ports.

5. The circuit of claim 4, wherein the controller delegates a greater amount of power to devices having a higher priority as set by the port manager and negotiated by the negotiation interface with each of the USB ports.

6. The circuit of claim 4, wherein the controller delegates a greater amount of power to devices having a lower priority as set by the port manager and negotiated by the negotiation interface with each of the USB ports if a device of higher priority is disconnected from its respective USB port.

7. The circuit of claim 4, wherein the controller delegates a greater amount of power to devices having a lower priority as set by the port manager and negotiated by the negotiation interface with each of the USB ports if a device of higher priority negotiates a lower power from its respective USB port than a device of lower priority negotiates from its respective USB port.

8. The circuit of claim 4, wherein the negotiation interface renegotiates the amount of power delegated by the controller to each remaining device connected to the respective USB ports if a given device is disconnected from its respective USB port.

9. The circuit of claim 4, wherein the negotiation interface sends or receives power allocation data on a configuration channel of the USB ports via a biphase mark coding protocol (BMC).

10. The circuit of claim 9, wherein the negotiation interface generates a source capability message via the configuration channel to a given device connected to the respective USB port, the negotiation interface to modify the source capability message sent to the given device to be a different voltage or a different current than requested based on the assigned priority or the amount of power requested.

11. A circuit, comprising:
a port manager to monitor requested port power from each of a plurality of universal serial bus (USB) ports, the port manager to set a separate port variable for each of the USB ports that indicates a priority in which each of the USB ports have requested port power, the port manager to analyze the requested port power from each of the plurality of USB ports and to determine an allocation of the port power for each of the USB ports based on the priority and an amount of power requested from each of the USB ports, the port manager to set a separate power variable for each of the USB ports that indicates the amount of power requested; and
a controller to monitor the separate port variables and power variables from the port manager for each of the USB ports, the controller to delegate power to the USB ports based on the priority and the amount of power requested.

12. The circuit of claim 11, further comprising a negotiation interface to negotiate the amount of power delegated by the controller to devices connected with each of the USB ports, wherein the controller delegates a greater amount of power to devices having a higher priority as set by the port manager and negotiated by the negotiation interface with each of the USB ports.

13. The circuit of claim 12, wherein the controller delegates a greater amount of power to devices having a lower priority as set by the port manager and negotiated by the negotiation interface with each of the USB ports if a device of higher priority is disconnected from its respective USB port, or the controller delegates a greater amount of power to devices having a lower priority as set by the port manager and negotiated by the negotiation interface with each of the USB ports if a device of higher priority negotiates a lower power from its respective USB port than a device of lower priority negotiates from its respective USB port.

14. A method, comprising:
monitoring requested port power from each of a plurality of universal serial bus (USB) ports;
updating a separate port variable for each of the USB ports that indicates a priority in which each of the USB ports have requested port power; and
delegating power to the USB ports based on the priority.

15. The method of claim 14, further comprising:
determining an amount of power requested from each of the USB ports; and
negotiating power to the USB ports based on the priority and the requested power.
